(19) United States
(12) Patent Application Publication
(10) Pub. No.: US 2026/0184094 A1
(43) Pub. Date: Jul. 2, 2026

(54) MACHINE TO TRANSFER INK FROM A WEB ONTO A CONTAINER

(71) Applicant: Norwalt Design, Inc., Randolph, NJ (US)

(72) Inventor: Michael Seitel, Randolph, NJ (US)

(73) Assignee: Norwalt Design, Inc., Randolph, NJ (US)

(21) Appl. No.: 19/378,910

(22) Filed: Nov. 4, 2025

Related U.S. Application Data
(60) Provisional application No. 63/741,160, filed on Jan. 2, 2025.

(51) Int. Cl. B41M 5/03; B41M 1/40; B41M 3/12

(52) U.S. Cl. CPC B41M 5/03; B41M 1/40; B41M 3/12

(57) ABSTRACT

A system for printing indicia onto a surface of a container includes an elongate web having indicia thereon; a web drum for moving the elongate web; a continuous container transfer station having a container holder for releasably securing a container. The continuous container transfer station configured for moving the container from an infeed container station to a web-container contact location. The container holder includes a motor system for moving the container into contact with the web and for moving the container away from contract with the web and includes at least one additional motor for rotating the container. Upon contact of the container to the web, the indicia is transferred from the web to the container. The at least one additional motor rotates the container whereby a tangential velocity of the container is substantially equal to a surface velocity of the web at a point of the web-container contact location.

### CROSS-REFERENCE TO RELATED APPLICATIONS

This application claims the benefit of U.S. Provisional Application No. 63/741,160, filed Jan. 2, 2025, the contents of which is incorporated by reference herein.

### FIELD OF THE INVENTION

The present invention is directed to a system for printing onto a surface of a container. In particular, the present invention is directed to a system using a web transfer for printing onto the surface of the container.

### BACKGROUND OF THE INVENTION

Providing a container with printed information or artwork may be done by first printing information or artwork onto a label and then securing the label to a surface of a container. The underlying label, however, often has portions not directly associated with the information or artwork, thereby resulting in the use of excess label material.

Web transfer printing of information or artwork onto a container is another method used to so customize containers. Misalignment of the transferred information or artwork onto a container may be problematic.

As such, there is a need in the art for improved web transfer printing of information and/or artwork onto a container.

### SUMMARY OF THE INVENTION

The present invention is directed to a system for transferring indicia, such as information and/or artwork, from a web onto a container. The indicia is typically printed indicia, but may include, in part, a foil of metallic material. The system provides improved and controlled transfer indicia from the web onto a surface of the container.

A system for printing indicia onto a surface of a container may include:
an elongate web having indicia thereon; a rotating device for moving the elongate web;
a continuous container transfer station having a plurality of container holders, each one of the plurality of container holders for releasably securing a container, the continuous container transfer station configured for moving the container from an infeed container station to a web-container contact location;
where each one of the container holders comprise a motor system for moving the container into contact with the web, for moving the container away from contact with the web, and for rotating the container;
where, upon contact of the container to the web, the indicia is transferred from the web to the container; and
where the motor system rotates the container whereby a tangential velocity of the container is substantially equal to a surface velocity of the web at a point of the web-container contact location.

The motors may be any suitable mechanical, pneumatic, or electric motors. The other device for rotating the container may include the use of gearing, use of forced air, etc.

The system may further include an ink station for printing the indicia onto a surface of the web. Alternatively, the indicia may be preprinted onto the surface of the web. The indicia disposed on the web typically includes a release layer, and ink layer, and an adhesive layer. The release layer may be disposed onto a surface of the web; where the ink layer is disposed over the release layer, and where the adhesive layer is disposed over the ink layer.

Upon contact of the container to the web and controlled rotation thereof, the adhesive layer is secured to the container with the ink layer being transferred from the web to the container.

The system may further include a web drum as the rotating device for guiding the web. The system may further include a belt, a motor, a pinion gear system, or other means for rotating the web drum controls the tangential velocity of the web at the web-container contact location.

The system may further include a rotating spindle or pulley as the rotating device for moving and controlling the tangential velocity of the web at the web-container contact location. The system may further include a backup guide for guiding the web at the web-container contact location.

The system also includes control of the tangential velocity of the container, where the motor system controls the tangential velocity of the container at the web-container contact location.

The system container holder may include an upper container holder and a lower container holder; and where the motor system includes first and second motors mechanically associated with the upper container holder and/or mechanically associated with the lower container holder. At least one of the first and second motors may be configured to controllably move the container towards and away from the web. At least one of the first and second motors may be configured to controllably rotate the container.

The system may further include a curing station for curing the ink layer and/or curing the adhesive layer.

A method for printing indicia onto a surface of a container, includes:
providing an elongate web having indicia thereon;
providing a rotating device for moving the elongate web;
providing a container releasably secured within a container holder;
providing a continuous container transfer station having a plurality of container holders;
providing a motor system mechanically associated with each of the container holders for moving the container towards the web and for rotating the container;
contacting the rotating container and the moving web at a web container contact location; and
transferring the indicia from the web onto a surface of the container while the continuous container transfer station is moving the container from an infeed container station to the web-container contact location.

A surface tangential velocity of the moving web and the tangential velocity of the rotating container are controlled to be substantially equal to each other while transferring the indicia from the web onto the surface of the container.

The continuous movement or transfer of the containers from an infeed container station to a discharge container station while indicia from the web is being transferred onto the surface of the container at the web container contact location. In other words, movement or transfer of the containers through the system is not halted or interrupted while the indicia is being disposed upon a container. As such, the system of the present invention has greater capacity or container thruput as compared to systems of the prior art.

These and other features and advantages of the present invention will become apparent from the following detailed description of illustrative embodiments thereof, which is to be read in connection with the accompanying drawings. Corresponding reference element numbers or characters indicate corresponding parts throughout the several views of the drawings.

### BRIEF DESCRIPTION OF THE DRAWINGS

FIG. 1 is a simplified schematic illustration of a system for transferring indicia from a web onto a container according to the present invention.

FIG. 2 is a partial upper view a web having indicia for transferring onto a container.

FIG. 3 is a cross-sectional view of the web of FIG. 2 taken along the 3-3 axis.

FIG. 4 is a partial exploded view of the indicia on the web of FIG. 2.

FIG. 5 is a schematic illustration showing details of an embodiment of the system of FIG. 1.

FIGS. 6A, 6B, 6C, 6D, 6E are schematic illustrations of the transfer of indicia from a web to a container according to the present invention.

FIG. 7 is a schematic illustration of a continuous rotary container transfer station according to the present invention.

FIG. 8 is an illustration of a system for holding and moving a container for the transfer of indicia from the web.

FIG. 9 is a schematic illustration showing details of another embodiment of the system of FIG. 1.

FIG. 10 is an exploded schematic illustration of the embodiment of the system of FIG. 9

FIG. 11 is a schematic illustration of a continuous elongate container transfer station according to the present invention.

### DETAILED DESCRIPTION OF THE INVENTION

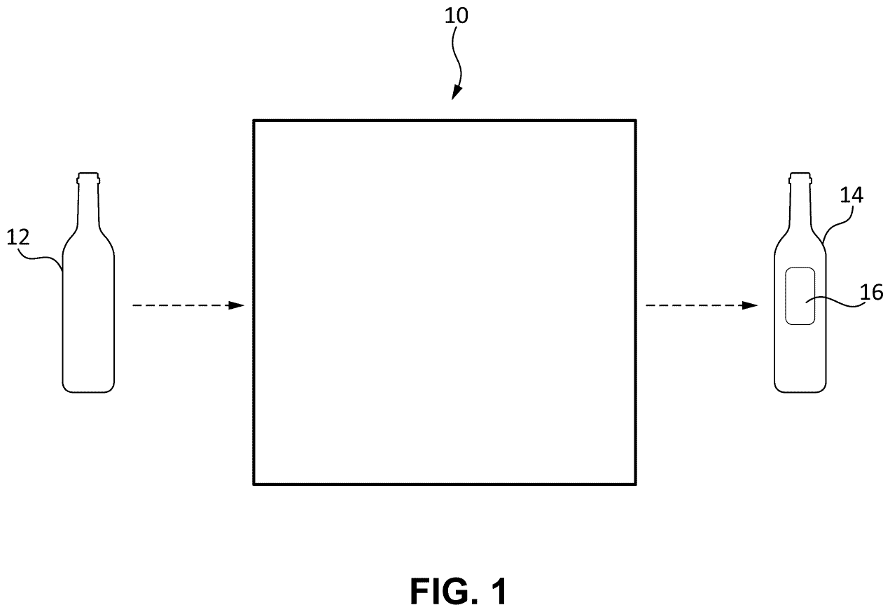

FIG. 1 is a simplified schematic illustration of the system 10 of the present invention. An article, such as a container 12, onto which indicia is to be applied is introduced into the system 10 of the present invention. The container 12 may be any container, such as but not limited to glass, plastic, metal, etc., useful in commercial, business, consumer, private, etc. applications. The system 10 provides a container 14 with applied indicia 16 thereon. The indicia may provide information about the contents of the container, consumer information for the container, decoration or artwork for the container, marketing information for the container, and/or any other desired marking or labelling.

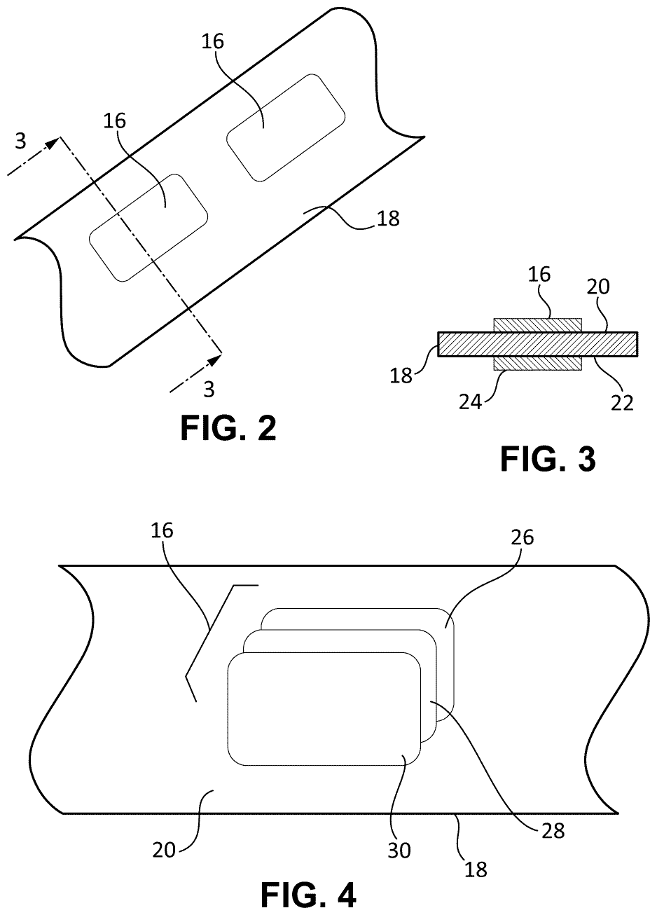

FIG. 2 is a partial top plan view of a portion of a web 18 having indicia 16 thereon. FIG. 3 is a cross-sectional view of the web of FIG. 2 taken along the 3-3 axis. The indicia 16 is disposed upon an inked side or face 20 of the web 18. The inked side 20 of the web 18 is proximally disposed towards a surface of the container 12 within the system 10. The opposed side or face 22 of the web 18 is disposed away from the surface of the container 12 within the system 10. The opposed side or face 22 of the web 18 may optionally contain a release layer 24. The release layer 24 may be useful for preventing the indicia 16 from adhering to portion of the web 18 when the web 18 is coiled or wound about itself. The release layer 24 may be especially useful where the indicia 16 is “pre-inked” onto a wound or coiled web. The present invention, however, as described below is not limited to the use of a “pre-inked” web.

The web 18 may be in the form of a carrier film for the transfer of the indicia 16. Useful materials for the web 18 may include, but are not limited to, polyethylene terephthalate (PET), polyethylene (PE), polypropylene (PP), polystyrene (PS), polyesters, polyamides, polyvinyl chloride, co-polymers such as styrene/acrylonitrile copolymers, ethylene/propylene copolymers, styrene/acrylonitrile copolymers, ethylene/butene-1, copolymers, ethylene/ethyl acrylate copolymers, ethylene/methyl methacrylate copolymers, ethylene/vinyl acetate copolymers.

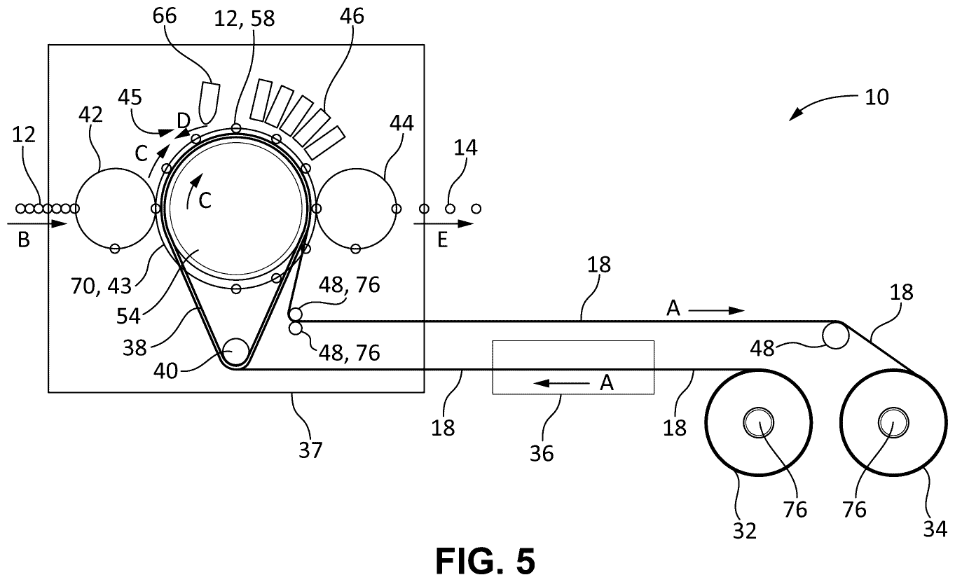

FIG. 4 further depicts details for the indicia 16. The indicia 16 may include a release layer 26, an ink layer 28, and an adhesive layer 30, inter-related as shown. The inked side 20 of the web 18 having the indicia 16 is side or face of the web 18 that is brought into contact, or at least proximal contact, with the face of the container 12. The adhesive layer 30 secures the ink layer 28 to the container 12. The release layer 26 permits separation of the ink layer 28 from the web 18. The release layer 26, the ink layer 28, and the adhesive layer 30 may have a common or substantially common or equal shape, but the present invention is not so limited.

As a non-limiting example, the adhesive layer 30 may include a pressure sensitive adhesive or contact adhesive. Such an adhesive, even at room temperature, will adhere to a multitude of container surfaces after being lightly pressed against them. The adhesive layer 30 may include an ultra-violet (UV) light curable pressure sensitive layer which upon exposure to high-intensity ultra-violet (UV) light results in a controllably, cured adhesive bond.

Suitable materials for the release layers 24, 26 may include, but are not limited to, silicone, high density polyethylene, medium density polyethylene, low density polyethylene, polypropylene, polytetrafluoroethylene, acrylated silicone, polyesters, polyethylene terephthalate, polyethylene naphthylene, polyamides, co-polymers and mixtures thereof.

FIG. 5 is a schematic illustration showing further details of the system 10 according to the present invention. If the containers 12 are being processed in an upright or vertical orientation, then FIG. 5 may be considered as a top planar view with vertical parts orientation. The present invention is not limited to such an upright or vertical orientation for the container 12. For example, the containers 12 may be processed in an orientation where the containers 12 are on their sides as opposed to being upright. In such a case, FIG. 5 may be considered an elevational view with horizontal parts orientation.

In either case, the web 18 is a continuous web from an unwind web station 32 to a rewind web station 34. Either or both of the unwind and rewind web stations 32, 34 may have a rotating pulley or spindle 76 for moving the web 18. In such a case the rotating pulley or spindle 76 may be mechanically configured for or associated with mechanical motive means, such as a motor. As depicted in FIG. 5 the web is unwound from the unwind web station 32 in a direction indicated by arrow “A” towards an ink station 36. The ink print station 36 applies the indicia 16 onto the surface 20 of the web 18. The indicia 16 may be printed or applied with a number of techniques common to the art of offset-sheet and web-based printing. Such printing includes, but is not limited to, flexographic printing, offset printing, digital printing, laser printing, inkjet printing, heat-set printing, gravure printing, and screen printing.

The ink layer 28 may include a formulation having a colorant to provide color to the ink layer 28. The ink layer 28 may include one or more colorants (e.g., one or more pigments, one or more dyes, or their mixtures). Colorants can provide the formulation with, for example, a desired color and/or opacity. Exemplary colors may include black, cyan, magenta, yellow, red, blue, green, brown, or their combinations. The indicia 16, however, is not limited to the use of inks in the ink layer 28. The indicia 16 may include, in part, a metalized portion or a portion of a metal foil (not shown) for adding, for example, decoration to the indicia or even a metalized indicia itself. Such a metalized indicia or a part of a metal foil may be applied to the web 18, or may be a part or portion of the web 18, or may include all of the web 18.

The inked web 18 then enters an indicia transfer station 37. The inked web 18 is guided by conveyor belt 38 and a pulley or roller 40 engaging the conveyor belt 38. The web 18 wraps around rotating device, such as a web drum 54. Containers 12 enter the indicia transfer station 37 as indicated by arrow “B”. An infeed container station 42 individually transports containers 12 towards a continuous container transfer station 70, such as a rotary container transfer station or turret 43.

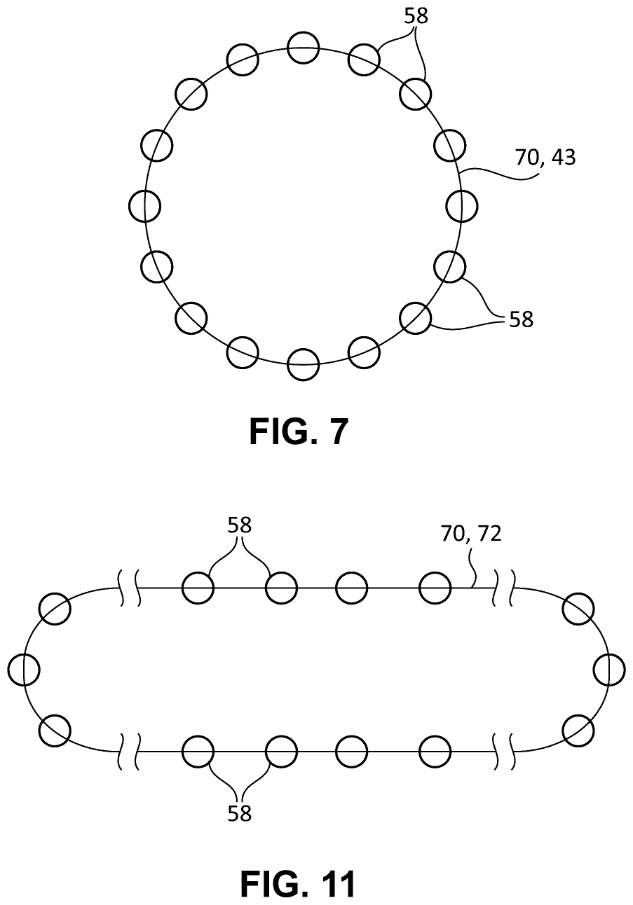

FIG. 7 schematically depicts continuous rotary container transfer station 70, such as the rotary container transfer station or turret 43. The continuous rotary container transfer station 70, 43 contains a plurality of container holders 58. In use, the continuous rotary container transfer station 70, 43 is in continuous motion while the indicia 16 is being applied to the container 12.

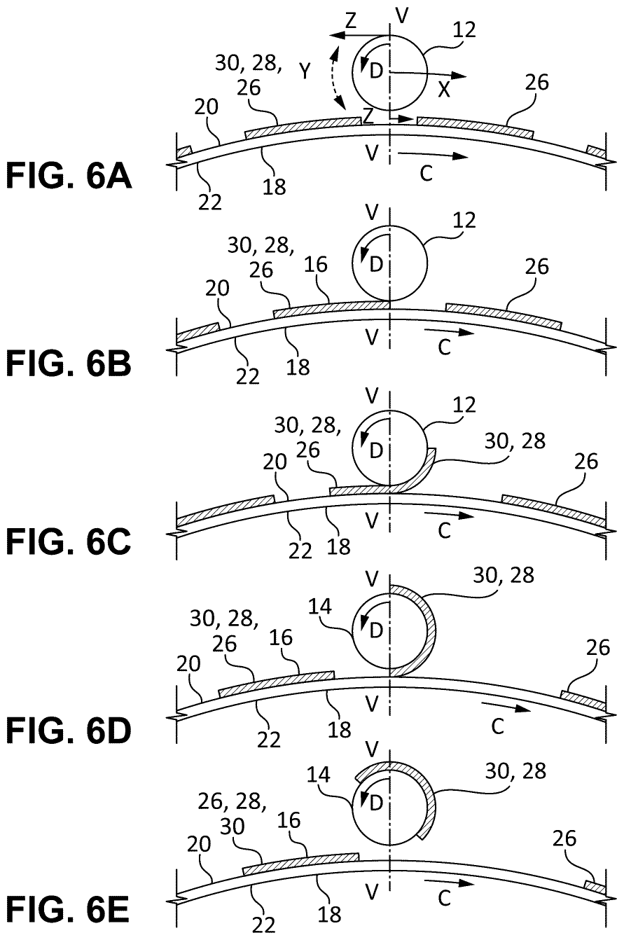

Returning to FIG. 5, the rotary container transfer station or turret 43 is shown as rotating in a clockwise direction “C”. The system of the present invention is not limited to a clockwise rotation of the rotary container transfer station or turret 43, and the rotary container transfer station or turret 43 may, if desired, rotate in the counter-clockwise direction. At a web-container contact location 45, which is generally indicated by arrow “D”, the indicia is transferred from the web 18 onto the container 12. Details of this transfer is further described below in conjunction with the description of FIGS. 6A-6F and 7. After the indicia 16 is applied to the container 12, the container is transported to a curing station 46. In the curing station 46 the ink layer 28 of the indicia 16 is cured. In one aspect of the present invention, the curing station may include UV curing lamps. Other curing devices may suitably be used depending upon the curing nature of the curable ink disposed onto the container 12. After the ink is cured, the container is transported to a discharge container station 44. The container 14 having the applied printing or indicia 16 exits the indicia transfer station 37 as indicated by arrow “E”. Further details of the infeed container station 42, the turret 43, and the discharge container station 44 are described in U.S. Patent Application Publications US 2021/0309022 A1 and US 2022/0219465 A1 both to Norwalt Design, Inc., the contents of both of which are incorporated herein in their entirety by reference.

The web 18 exits the indicia transfer station 37 as indicated by arrow “E” to the rewind web station 34. The web 18 may be guided by rollers or pulleys 48. At the rewind web station 34 the web 18 is wound into a coil. Alternatively, the web 18 may be a continuous loop (not shown). In such a case, there may be a cleaning station (not shown) prior to be send back the print station 36 to so clean the web before applying ink. Movement of the web 18 is not limited to the use of the web drum 54 for providing motive force to the web 18. Other rotating devices, such as rotating pulleys or spindles 76, typically motorized, may be used, in conjunction or separately, for moving the web 18. For example, movement of the web 18 controlled by the unwind web station 32 and/or the rewind web station 34 through the use of motorized pulleys or spindles 76.

FIGS. 6A to 6E schematically illustrate the transfer of the indicia 16 from the web 18 onto a container 12. As depicted in FIG. 6A the web 18 is moving or rotating in one direction about a lateral axis “V”, for example a clockwise direction of the moving turret 43 (not shown), as indicated by arrow “C”. The container 12 is also moving or rotating in the same direction about the lateral axis “V”, for example a clockwise direction, as indicated by arrow “D”. Arrow “Z” depicts the surface or tangential velocities. The surface or tangential velocity “Z” of the web 18 should be equal, including substantially equal, to the tangential velocity “Z” of the container 12. Mathematically, if “X” indicates the revolutions per minute (rpm) of the container 12 and of “Y” surface length or circumference of the container 12 (or length per revolution of the container 12), then the web 18 should be controllably traveling at a rate of “X times Y”. With the system 10 of the present invention the spinning or revolutions per minute of the container 12 and the speed of the web 18 are independently controlled so that the tangential velocity of the container 12 and the tangential velocity of the web 18 are equal or at least substantially equal. This allows for proper and controllable deposition of the indicia 16 onto the container 12. Further, the system of the present invention rotate a container 12 only when it is being proximally disposed, including juxtaposingly disposed, towards the web 18.

FIG. 6B schematically depicts the initial engagement of the rotating container 12 against the rotating indicia 16. Such initial engagement is proximal juxtaposingly engagement of the container 12 and the indicia 16. Components for achieving such juxtaposingly engagement are described below in conjunction with FIG. 7. Referring back to FIG. 6B, the rotating container 12 contacts the adhesive layer 30 of the indicia 16.

As schematically depicted in FIG. 6C, the adhesive layer 30 and the ink layer 28 being secured to the rotating container 12. The adhesive layer 30 and the ink layer 28 are being lifted away from the release layer 26 of the indicia 16. As schematically depicted in FIG. 6D, with continued, controlled rotation of the container 12 the ink layer 28 of the indicia 16 is secured to the container 12 via the adhesive layer 30. The release layer 26 of the indicia 16 remains on the rotating web 18. As schematically depicted in FIG. 6E, the container 14 having the adhesively secured ink layer 28 is moved away from the rotating web 18.

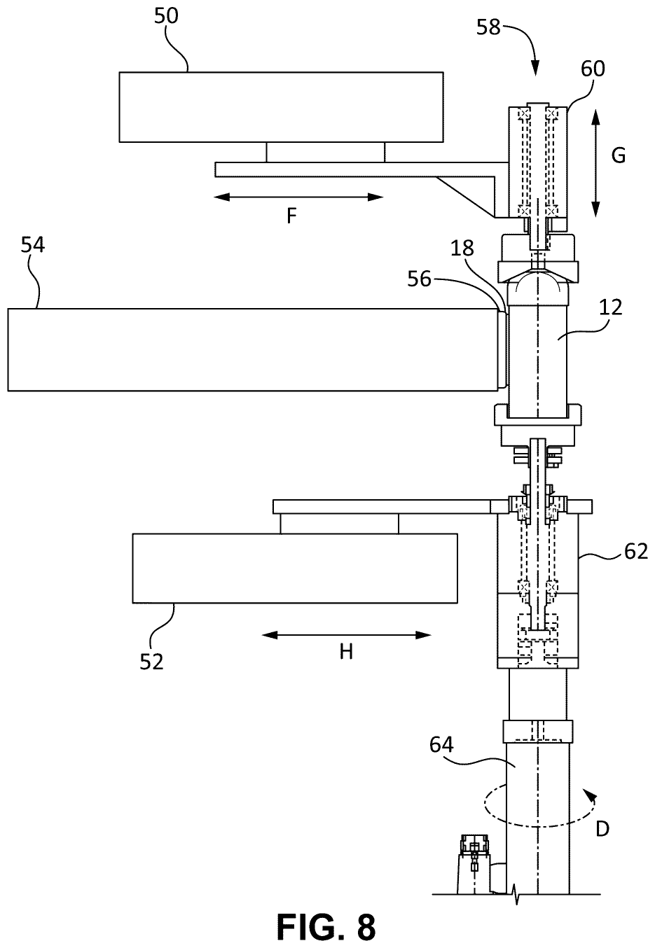

FIG. 8 depicts components for controllably securing, moving, and rotating the container 12. The container 12 is releasably secured within a container holder 58. In particular, the container 12 is releasably secured between an upper holder 60 and a lower holder 62. An upper motor 50 is mechanically associated with the upper holder 60. The upper motor 50 may be configured to provide controllable lateral motion, as indicated by arrow “F”, and/or configured to provide controllable vertical motion, as indicated by arrow “G”, of the container 12 and the container holder 28. With the controllable lateral motion “F”, the upper motor 50 may move in and out from the rotary container transfer station or turret 43 to contact the web 18. One aspect of the controllable vertical motion “G” is to provide up and down motion for releasably securing or clamping the container 12 within the container holder 58.

A lower motor 52 is mechanically associated with the lower holder 62. The lower motor 52 may be configured to provide controllable lateral motion, as indicated by arrow “H”, of the container 12 and the container holder 28. Thus, both the upper holder 60 and the lower holder 62 have independent motors 50, 52, respectively, for independently controlling different movements. The upper motor 50 and/or the lower motor 52 provide consistent or substantially consistent lateral movement.

The upper and lower motors 50, 52 may be any mechanical, pneumatic, electrical motors. Desirably, the upper and lower motors 50, 52 are servomotors.

A container holder motor 64 is provided for providing controllable rotation of the container 12. While the container holder motor 64 is depicted as being mechanically associated with the lower holder 62, the present invention is not so limited and other configurations may suitably be used. The upper holder 60 and the lower holder 62 may be separately mounted on the rotary container transfer station or turret 43. Such separate mounting may avoid interference between the container holder 58. Desirably, the container holder motor 64 is configured to rotate the container 12 through the use of one or more motors 64. The container 12, however, may be rotated by other means, such as gearing or forced air flow.

Continuing with FIG. 8, a rotating device or web drum 54, optionally having a belt 56 or other motive means such as gearing or motor, is provided for controllably moving and guiding the web 18. The web drum 54 may also optionally have a vacuum source to aid in control of the web. Such controllable contact is described above in conjunction with FIGS. 6A to 6F.

Returning to FIG. 5, an inspection module or camera 66 may be provided to monitor the controlled contact of the web 18 and the container 12. In particular, the inspection module or camera 66 may monitor the proper placement of the indicia 16 onto the container 12. Feedback (not shown) may be provided from the inspection module or camera 66 to the upper servomotor 50, the lower servomotor 52, the container holder servomotor 64, and/or the web drum 54 to ensure proper deposition of the indicia 16 onto the container 12.

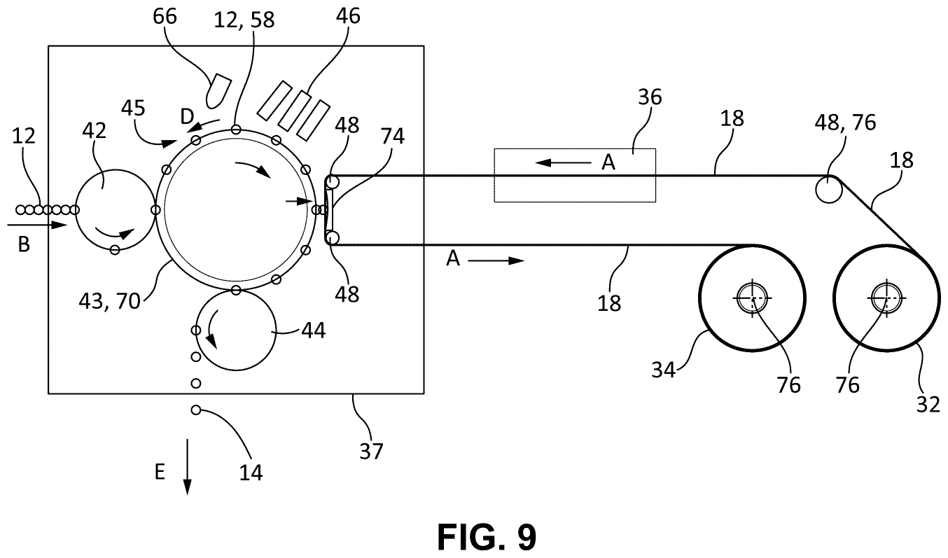

The present invention is not limited to the use of a web drum 54 for guiding or moving the web 18. For example, as schematically depicted in FIG. 9 the web 18 may move from the unwind web station 32 to a location proximal the continuous transfer station 70. The location may include web pulleys 48 and a backup guide 74. The web 18 is disposed between the container 18 and the backup guide 74 at the web-container contact location 45. The backup guide 74 may be rubber, plastic, or polymeric based material. The backup guide 74 should have some flexibility to ensure adequate contact between the web 18 and the container 12 when the container holder 58 is controllably moved into the position for transferring the indicia 16 from the web 18. As such the backup guide 74 may have a degree of elasticity to provide flexibility to the backup guide 74.

If the containers 12 are being processed in an upright or vertical orientation, then FIG. 9 may be considered as a top planar view with vertical parts orientation. The present invention is not limited to such an upright or vertical orientation for the containers 12. For example, the containers 12 may be processed in an orientation where the containers 12 are on their sides as opposed to being upright. In such a case, FIG. 9 may be considered an elevational view with horizontal parts orientation.

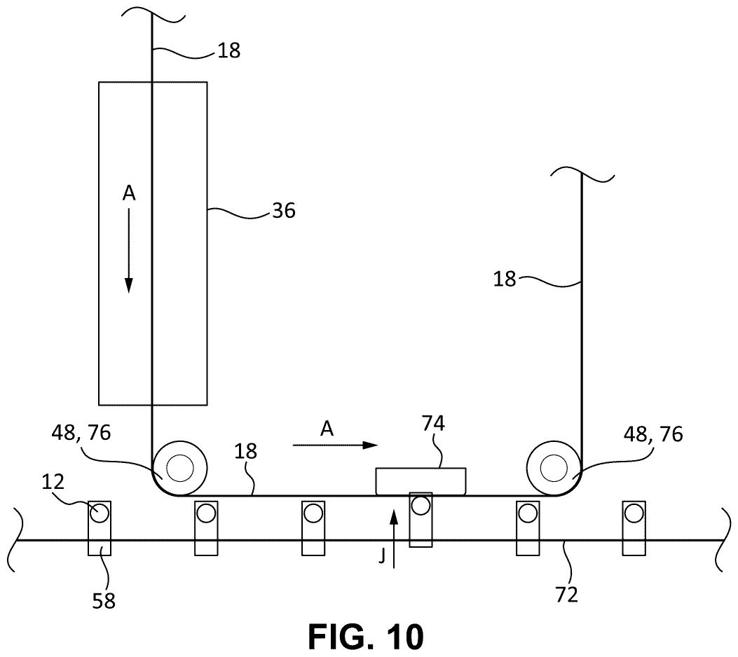

The embodiment of FIG. 9 is not limited to the use of the rotary container transfer station 43. For example, as depicted in FIGS. 10 and 11, an elongate container transfer station 72 may be used. As shown in FIG. 11, the elongate container transfer station 72 is a continuous system having a plurality of container holders 58. The elongate container transfer station 72 may be in the shape of an elongate rectangle having rounded ends, such as capsule-shaped configuration. As depicted in FIG. 10, a container holder 58 having a container 12 therein is transported to the web-container contact location 45. At the web-container contact location 45 the container 12 is moved against the web 18, as indicated by arrow J, for the transfer of the indicia 16. As described above, rotation of the container 12 within the container holder 58 is controlled such that the tangential velocity of the container 12 is substantial equal to the surface velocity of the web 18.

While various embodiments of the present invention are specifically illustrated and/or described herein, it will be appreciated that modifications and variations of the present invention may be affected by those skilled in the art without departing from the spirit and intended scope of the invention. Further, any of the embodiments or aspects of the invention as described in the claims or in the specification may be used with one and another without limitation.

Element reference numbers, letters, and/or symbols in the following embodiments or aspects of the present invention are presented merely for ease of comprehension and are not to be construed as limiting the scope of the present invention. Further, the following embodiments or aspects of the invention may be combined in any fashion and combination and be within the scope of the present invention, as follows:
Embodiment 1. A system (10) for printing indicia (16) onto a surface of a container (12), comprising:
   an elongate web (18) having indicia (16) thereon;
   a rotating device (54, 76) for moving the elongate web (18);
   a continuous container transfer station (43, 70, 72) having a plurality of container holders, each one of the plurality of container holders (58) for releasably securing a container (12), the continuous container transfer station (43, 70, 72) configured for moving the container (12) from an infeed container station (42) to a web-container contact location (45);
   wherein each one of the plurality of container holders (58) comprises a motor system (50, 52, 64) for moving the container (12) into contact with the web (18), for moving the container (12) away from contract with the web (18), and for rotating the container (12);
   wherein, upon contact of the container (12) to the web (18), the indicia (16) is transferred from the web (18) to the container (12); and
   wherein the motor system (64) rotates the container (12) whereby a tangential velocity of the container (12) is substantially equal to a surface velocity of the web (18) at a point of the web-container contact location (45).
Embodiment 2. The system (10) of embodiment 1, wherein the indicia (16) comprises an ink layer (28).
Embodiment 3. The system (10) of embodiment 1 or any previous embodiments, wherein the indicia (16) disposed on the web (18) comprises a release layer (26), and ink layer (28), and an adhesive layer (30).
Embodiment 4. The system (10) of embodiment 3 or any previous embodiments,

wherein the release layer (26) is disposed onto a surface (20) of the web (18); wherein the ink layer (28) is disposed over the release layer (26), and wherein the adhesive layer (30) is disposed over the ink layer (28).
Embodiment 5. The system (10) of embodiment 4 or any previous embodiments, wherein, upon contact of the container (12) to the web (18) and controlled rotation thereof, the adhesive layer (30) is secured to the container (12) with the ink layer (28) being transferred from the web (18) to the container (12) and with the release layer (26) remaining with the web (18).
Embodiment 6. The system (10) of embodiment 1 or any previous embodiments, wherein the rotating device (54, 76) is a web drum (54) for guiding the web (18).
Embodiment 7. The system of embodiment 6, further comprising a belt (38, 56), a motor, a pinion gear system, or other means for rotating the web drum (54) controls the tangential velocity of the web (18) at the web-container contact location (45).
Embodiment 8. The system (10) of embodiment 1 or any previous embodiments 2-5, wherein the rotating device (54, 76) is a rotating spindle or pulley (76) for moving and controlling the tangential velocity of the web (18) at the web-container contact location (45).
Embodiment 9. The system of embodiment 8, further comprising a backup guide (74) for guiding the web (18) at the web-container contact location (45).
Embodiment 10. The system (10) of embodiment 7, wherein the motor system (64) controls the tangential velocity of the container (12) at the web-container contact location (45).
Embodiment 11. The system (10) of embodiment 8, wherein the motor system (64) controls the tangential velocity of the container (12) at the web-container contact location (45).
Embodiment 12. The system (10) of embodiment 1 or any previous embodiments, wherein the container holder (58) comprises an upper container holder (60) and a lower container holder (62); and wherein the motor system (50, 52, 64) comprises first and second motors (50, 52, 64) mechanically associated with the upper container holder (60) and/or mechanically associated with the lower container holder (62).
Embodiment 13. The system (10) of embodiment 9 or any previous embodiments, wherein at least one the first and second motors (50, 52, 64) are configured to controllably move the container (12) towards and away from the web (18) and/or to rotate the container (12).
Embodiment 14. The system (10) of embodiment 5 or any previous embodiments 6-13, further comprising a curing station (46) for curing the ink layer (28) and/or curing the adhesive layer (30).
Embodiment 15. A container packaging assembly comprising the system (10) of embodiment 1 or any previous embodiments.
Embodiment 16. A method for printing indicia (16) onto a surface of a container (12), comprising:
   providing an elongate web (18) having indicia (16) thereon;
   providing a rotating device (54, 76) for moving the elongate web (18);
   providing a container (12) releasably secured within a container holder (58);
   providing a continuous container transfer station (43, 70, 72) having a plurality of container holders (58);
   providing a motor system (50, 52, 64) mechanically associated with each one of the plurality of container holders (58) for moving the container (12) towards the web (18) and for rotating the container (18);
   contacting the rotating container (12) and the moving web (18) at a web container contact location (45); and
   transferring the indicia (16) from the web (18) onto a surface of the container (12) while the continuous container transfer station (43, 40, 72) is moving the container (12) from an infeed container station (42) to the web container contact location (45).
Embodiment 17. The method of embodiment 16, wherein the moving web (18) has a surface velocity and wherein a tangential velocity of the rotating container (12) is substantially equal to the surface velocity of the web (18) while transferring the indicia (16) from the web (18) onto the surface of the container (12).

What is claimed is:

1. A system for printing indicia onto a surface of a container, comprising:
an elongate web having indicia thereon;
a rotating device for moving the elongate web;
a continuous container transfer station having a plurality of container holders, each one of the plurality of container holders for releasably securing a container, the continuous container transfer station configured for moving the container from an infeed container station to a web-container contact location;
wherein each one of the container holders comprise a motor system for moving the container into contact with the web, for moving the container away from contact with the web, and for rotating the container;
wherein, upon contact of the container to the web, the indicia is transferred from the web to the container; and
wherein the motor system rotates the container whereby a tangential velocity of the container is substantially equal to a surface velocity of the web at a point of the web-container contact location.

2. The system of claim 1, wherein the indicia comprises an ink layer.

3. The system of claim 1, wherein the indicia disposed on the web comprises a release layer, and ink layer, and an adhesive layer.

4. The system of claim 3, wherein the release layer is disposed onto a surface of the web; wherein the ink layer is disposed over the release layer, and wherein the adhesive layer is disposed over the ink layer.

5. The system of claim 4, wherein, upon contact of the container to the web and controlled rotation thereof, the adhesive layer is secured to the container with the ink layer being transferred from the web to the container and with the release layer remaining with the web.

6. The system of claim 1, wherein the rotating device is a web drum for guiding the web.

7. The system of claim 6, further comprising a belt, a motor, a pinion gear system, or other means for rotating the web drum controls the tangential velocity of the web at the web-container contact location.

8. The system of claim 1, wherein the rotating device is a rotating spindle or pulley for moving and controlling the tangential velocity of the web at the web-container contact location.

9. The system of claim 8, further comprising a backup guide for guiding the web at the web-container contact location.

10. The system of claim 7, wherein the motor system controls the tangential velocity of the container at the web-container contact location.

11. The system of claim 8, wherein the motor system controls the tangential velocity of the container at the web-container contact location.

12. The system of claim 1, wherein the container holder comprises an upper container holder and a lower container holder; and wherein the motor system comprises first and second motors mechanically associated with the upper container holder and/or with the lower container holder.

13. The system of claim 12, wherein at least one of the first and second motors are configured to controllably move the container towards and away from the web and/or to rotate the container.

14. The system of claim 5, further comprising a curing station for curing the ink layer and/or curing the adhesive layer.

15. A container packaging assembly comprising the system of claim 1.

16. A method for printing indicia onto a surface of a container, comprising:
providing an elongate web having indicia thereon;
providing a rotating device for moving the elongate web;
providing a container releasably secured within a container holder;
providing a continuous container transfer station having a plurality of container holders;
providing a motor system mechanically associated with each of the container holders for moving the container towards the web and for rotating the container;
contacting the rotating container and the moving web at a web container contact location; and
transferring the indicia from the web onto a surface of the container while the continuous container transfer station is moving the container from an infeed container station to the web-container contact location.

17. The method of claim 16, wherein the moving web has a surface velocity and wherein a tangential velocity of the rotating container is substantially equal to the surface velocity of the web while transferring the indicia from the web onto the surface of the container.
